(19) United States
(12) Patent Application Publication
(10) Pub. No.: US 2022/0279852 A1
(43) Pub. Date: Sep. 8, 2022

(54) A Cartridge for an Electronic Cigarette, An Electronic Cigarette, and an Assembly Method for an Electronic Cigarette

(71) Applicant: JT International SA, Geneva (CH)

(72) Inventors: Paul Voerman, Apeldoorn (NL); Sebo Popken, Nieuwleusen (NL); Ernst Hupkes, Kampen (NL)

(73) Assignee: JT International SA, Geneva (CH)

(21) Appl. No.: 17/634,773

(22) PCT Filed: Aug. 10, 2020
(86) PCT No.: PCT/EP2020/072415

§ 371 Date: Feb. 11, 2022

(30) Foreign Application Priority Data
Aug. 12, 2019 (EP) 19191198.1

(51) Int. Cl. A24F 40/46; A24F 40/10; A24F 40/42; A24F 40/44; A24F 40/485; A24F 40/70; H05B 3/00

(52) U.S. Cl. CPC A24F 40/46; A24F 40/10; A24F 40/42; A24F 40/44; A24F 40/485; A24F 40/70; H05B 3/0014; H05B 2203/037

(57) ABSTRACT

A cartridge for an electronic cigarette is configured to thermically connect to a base part having at least one heating element. The cartridge includes: a liquid store including a liquid outlet; a vaporization chamber in communication with the liquid store via the liquid outlet; a sorption member in the vaporization chamber for absorbing liquid transferred to the vaporization chamber via the liquid outlet; and a heat transfer unit configured, when the cartridge is thermically connected to the base part, to transfer heat from the heating element to the sorption member to vaporize liquid absorbed by the sorption member. The sorption member and the heat transfer unit are only in partial contact in contact zones.

### TECHNICAL FIELD

The present disclosure relates generally to electronic cigarettes. Embodiments of the present disclosure relate in particular to a cartridge for an electronic cigarette and to an assembly method for an electronic cigarette.

### TECHNICAL BACKGROUND

Electronic cigarettes are an alternative to conventional cigarettes. Instead of generating a combustion smoke, they vaporize a liquid which can be inhaled by a user. The liquid typically comprises an aerosol-forming substance, such as glycerine or propylene glycol, that creates the vapour when heated. Other common substances in the liquid are nicotine and various flavourings.

The electronic cigarette is a hand-held inhaler system, typically comprising a mouthpiece section, a liquid store and a power supply unit. Vaporization is achieved by a vaporizer or heater unit which typically comprises a heating element in the form of a heating coil and a fluid transfer element such as a wick. Vaporization occurs when the heater heats the liquid in the wick until the liquid is transformed into vapour.

Conventional cigarette smoke comprises nicotine as well as a multitude of other chemical compounds generated as the products of partial combustion and/or pyrolysis of the plant material. Electronic cigarettes on the other hand deliver primarily an aerosolized version of an initial starting e-liquid composition comprising nicotine and various food safe substances such as propylene glycol and glycerine, etc., but are also efficient in delivering a desired nicotine dose to the user. Electronic cigarettes need to deliver a satisfying amount of vapour for an optimum user experience whilst at the same time maximizing energy efficiency.

WO2017/179043 discloses an electronic cigarette comprising a disposable cartridge and a reusable base part. The cartridge has a simplified structure which is achieved by keeping the main heating element in the re-usable base part, while the cartridge is provided with a heat transfer unit. The heat transfer unit is configured to transfer heat from the heating element to the proximity of liquid in the cartridge to produce a vapour for inhalation by a user.

It would be advantageous to further improve the energy efficiency of the electronic cigarette described in WO2017/179043 so that less heat is conveyed to the liquid store in the cartridge.

### SUMMARY OF THE DISCLOSURE

It is an object of the present disclosure to provide disposable cartridges that are economical to produce, and which require low energy consumption when used together with a cooperating base part of an electronic cigarette.

According to a first aspect of the present disclosure, there is provided a cartridge for an electronic cigarette, the cartridge being configured to thermically connect to a base part having at least one heating element, the cartridge comprising:
a liquid store comprising a liquid outlet;
a vaporization chamber in communication with the liquid store via the liquid outlet;
a sorption member in the vaporization chamber for absorbing liquid transferred to the vaporization chamber via the liquid outlet; and
a heat transfer unit configured, when the cartridge is thermically connected to the base part, to transfer heat from the heating element to the sorption member to vaporize liquid absorbed by the sorption member;
wherein the sorption member and the heat transfer unit are only in partial contact in contact zones.

According to a second aspect of the present disclosure, there is provided an electronic cigarette comprising:
a base part having at least one heating element; and
a cartridge according to the first aspect thermically connected to the base part.

The base part may include a power supply unit, e.g. a battery, connected to the heating element. In operation, upon activating the electronic cigarette, the power supply unit electrically heats the heating element of the base part, which then provides its heat by conduction to the heat transfer unit of the cartridge. The heat transfer unit, in turn, provides the heat to the sorption member, resulting in vaporization of the liquid absorbed therein.

As this process is continuous, liquid from the liquid store is continuously absorbed by the sorption member. Vapour created during the above process is transferred from the vaporization chamber via a vapour outlet channel in the cartridge so that it can be inhaled by a user of the electronic cigarette.

A concentration of heat is present in the sorption member in the contact zones primarily due to conduction of heat from the heat transfer unit to the sorption member in the contact zones. The heat input to the sorption member is, therefore, maximized in the contact zones whilst heat transfer to other component parts of the cartridge and/or the electronic cigarette, and in particular the liquid in the liquid store, is minimized. Thus, the majority of heat generated by the heating element is used to heat liquid absorbed by the sorption member and, thus, for vapour generation, thereby maximizing energy efficiency and reducing the energy consumption of the electronic cigarette.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

As used herein, the term “electronic cigarette” may include an electronic cigarette configured to deliver an aerosol to a user, including an aerosol for smoking. An aerosol for smoking may refer to an aerosol with particle sizes of 0.5 to 10 μm. The particle size may be less than 10 or 7 μm. The electronic cigarette may be portable.

The heat transfer unit may comprise a plurality of first portions lying substantially in a first plane and may comprise a plurality of second portions stepped out of the first plane and lying substantially in a second plane. The second plane may be below the first plane and may be substantially parallel with the first plane. The plurality of second portions may contact the sorption member in the contact zones. Heat is transferred from the heat transfer unit to the sorption member in the contact zones primarily by conduction from the second portions of the heat transfer unit to the sorption member. This further maximizes energy efficiency and reduces the energy consumption of the electronic cigarette.

The heat transfer unit may comprise a substantially circular heat transfer unit. The first portions may be circumferentially spaced around the heat transfer unit and the second portions may be circumferentially spaced around the heat transfer unit. The second portions may be arranged circumferentially between the first portions. The heat transfer unit is conveniently shaped for use with a cartridge having a cylindrical form and can be manufactured with relative ease.

The first portions may be substantially planar. The first portions may have an upper surface and a lower surface. The upper surface may be configured to contact the heating element of the base part. A plurality of vaporization zones may be formed between the lower surface of the first portions and the sorption member. The vaporization zones conveniently facilitate vapour generation due to heating of the liquid absorbed by the sorption member.

The heat transfer unit may include a plurality of formations which contact the sorption member in the contact zones. The formations may comprise a plurality of projections, e.g., frustoconical projections, or a plurality of nodules, e.g., hemispherical nodules. Heat is transferred from the heat transfer unit to the sorption member in the contact zones primarily by conduction from the formations to the sorption member.

The heat transfer unit may comprise a sheet material having a thickness of approximately 0.05 mm. The relatively thin nature of the sheet material may facilitate manufacture of the heat transfer unit, e.g. by a forming process performed on the sheet material, whilst minimising the risk of cracking of the sheet material. In some embodiments, the thickness could be between 0.01 mm and 0.20 mm, possibly between 0.03 mm and 0.10 mm. The forming process may be a stamping process. Other manufacturing processes could, however, be employed including (but not limited to) die casting and cold forging.

The cartridge may further comprise a plurality of air inlets in communication with the vaporization zones, and at least one air inlet may be in communication with each vaporization zone. The air inlets facilitate vapour generation in the vaporization zones.

The cartridge may comprise a housing, may comprise a plug member and may comprise a circumferential seal. The plug member may be configured to retain the heat transfer unit. The heat transfer unit may be configured to retain the sorption member. This arrangement may facilitate assembly of the cartridge.

The circumferential seal may comprise a plurality of slits. The slits may be aligned with the first portions of the heat transfer unit, whereby the slits form air inlet openings to the vaporization zones. As noted above, the air inlets facilitate vapour generation in the vaporization zones and by forming the slits in the circumferential seal, manufacture of the cartridge may be simplified.

The heat transfer unit may be received in the circumferential seal. The circumferential seal may comprise an annular groove which may be configured to receive a circumferential edge of the heat transfer unit. This may further facilitate assembly of the cartridge.

The plug member may comprise a first protruding connection end configured to sealingly connect to a vapour outlet channel of the housing and may comprise a second connection end configured to seal against an inner circumference of the circumferential seal. The plug member provides a secure route for vapour flow from the vaporization zones to the vapour outlet channel.

The plug member may comprise a plurality of liquid outlets from the liquid store. Each vaporization zone may be aligned with at least one liquid outlet. The liquid outlets provide a controlled flow of liquid from the liquid store to the corresponding vaporization zones, thereby optimising vapour formation in the vaporization zones due to heat transfer from the heat transfer unit to the sorption member.

The heat transfer unit may further comprise a central portion which may define a central chamber. The central portion may lie substantially in the first plane. Put another way, the central portion may be raised substantially to a level corresponding to the first portions. The plurality of first portions may be fluidically connected with the central chamber. The central chamber may be fluidically connected to a vapour outlet channel, whereby vapour can be transferred from each vaporization zone to the vapour outlet channel. The central chamber provides a convenient route for transferring vapour from the vaporization zones to the vapour outlet channel. The central chamber also facilitates manufacture of the heat transfer unit and may help to ensure its structural integrity, in particular if the heat transfer unit is formed by a stamping operation to create the first and second portions.

The sorption member may be disc shaped and may include a hole which may extend therethrough for establishing fluid communication between the vaporization zones and a vapour outlet channel. Thus, vapour generated in the vaporization zones can be readily transferred to the vapour outlet channel.

The sorption member may have a non-planar surface which may face towards the heat transfer unit. The non-planar surface may comprise a plurality of recessed areas in a surface of the sorption member and the recessed areas may face towards, and may be aligned with, the first portions of the heat transfer unit. The recessed areas increase the size of the vaporization zones and may allow an increased amount of vapour to be generated.

The sorption member can be made of any material or a combination of materials being able to perform sorption and/or absorption of another material, and can be made, for example, of one or more of the following materials: fibre, glass, aluminium, cotton, ceramic, cellulose, glass fibre wick, stainless steel mesh, polyethylene (PE), polypropylene, polyethylene terephthalate (PET), poly(cyclohexanedimethylene terephthalate) (PCT), polybutylene terephthalate (PBT), polytetrafluoroethylene (PTFE), expanded polytetrafluoroethylene (ePTFE), and BAREX®, etc.

The heating element of the base part may comprise a substantially planar heat transfer surface in contact with the plurality of first portions. The first portions of the heat transfer unit are heated due to the contact between the first portions and the planar heat transfer surface, with the second portions being heated indirectly by heat transferred from the first portions. This arrangement may allow the use of a heating element with a simple geometry.

The heating element of the base part may comprise a plurality of heat transfer surfaces in contact with each of the second portions. The second portions of the heat transfer unit are heated directly due to the contact between the second portions and the corresponding heat transfer surfaces of the heating element. Heating of the first portions, which are not in contact with the sorption member, is thereby minimised which means that heat is transferred more efficiently from the heat transfer unit to the sorption member in the contact zones. This in turn reduces energy consumption. It may also reduce the temperature of the heat transfer unit, and in particular the temperature of the first portions. This in turn reduces heat transfer to other parts of the cartridge and the electronic cigarette, thereby further reducing energy consumption and possibly reducing the temperature of an outer surface of the electronic cigarette which can improve user comfort.

The heating element may include a first layer comprising a thermally-insulating material and may include a second layer comprising a thermally-conductive material. A resistive heater element, e.g., a heater wire, may be positioned at an interface between the first and second layers or may be embedded in the second (thermally conductive) layer. The heat transfer surfaces may be provided on the second layer. Thus, heat transfer from the resistive heater element to the heat transfer surfaces is promoted by the first (thermally conductive) layer, whilst heat transfer to other parts of the heating element is minimized by the first (thermally insulating) layer. This may help to maximize heating efficiency.

The heat transfer unit may comprise a thermally conductive material, for example, a metal such as aluminium, copper, etc.

The heating element may comprise an electrically resistive material. The heating element may include a ceramic material, for example tungsten and alloys thereof. The use of a ceramic material conveniently helps to rigidify the heating element. The heating element may be at least partially encapsulated in, or coated with, a protective material, such as glass.

The heating element may be formed using a metal having a defined relationship between temperature and resistivity. In such embodiments, the metal may be formed as a track between two layers of suitable insulating materials. A heating element formed in this manner may be used both as a heater and a temperature sensor.

The heating element may include a temperature sensor embedded therein or attached thereto.

The power supply unit, e.g. battery, may be a DC voltage source. For example, the power supply unit may be a Nickel-metal hydride battery, a Nickel cadmium battery, or a Lithium based battery, for example a Lithium-Cobalt, a Lithium-Iron-Phosphate, a Lithium-Ion or a Lithium-Polymer battery.

The base part may further comprise a processor associated with electrical components of the electronic cigarette, including the battery.

The cartridge may further comprise: a cartridge housing at least partially including the liquid store and the vaporization chamber, and a vapour outlet channel extending along the cartridge housing and in fluid communication with the vaporization chamber. The cartridge housing may have a proximal end configured as a mouthpiece end which is in fluid communication with the vaporization chamber via the vapour outlet channel and a distal end associated with the heat transfer unit. The mouthpiece end may be configured for providing the vaporized liquid to the user. The heat transfer unit may be disposed at the distal end. The heat transfer unit may be substantially perpendicular to the vapour outlet channel.

The liquid store may be juxtaposed with the vapour outlet channel extending between the vaporization chamber and the mouthpiece end. The liquid store may be disposed around the vapour outlet channel.

The cartridge housing may be made of one or more of the following materials: aluminium, polyether ether ketone (PEEK), polyimides, such as Kapton®, polyethylene terephthalate (PET), polyethylene (PE), high-density polyethylene (HDPE), polypropylene (PP), polystyrene (PS), fluorinated ethylene propylene (FEP), polytetrafluoroethylene (PTFE), polyoxymethylene (POM), polybutylene terephthalate (PBT), Acrylonitrile butadiene styrene (ABS), Polycarbonates (PC), epoxy resins, polyurethane resins and vinyl resins.

According to a third aspect of the present disclosure, there is provided an assembly method for a cartridge for an electronic cigarette, the cartridge comprising a housing having a closed end and an open end configured to receive a plug member, the method comprising the steps of:
providing a plug member with a cavity;
placing a disc shaped sorption member in the cavity;
attaching a heat transfer unit to the plug member such that the heat transfer unit secures the sorption member in the cavity and such that the sorption member and the heat transfer unit are only in partial contact in contact zones; and
introducing the plug member into the open end of the housing.

The cartridge has a simple structure with a reduced number of component parts when compared to conventional cartridges for use with electronic cigarettes. Thus, the cartridge can be assembled with ease by the above method and the method can conveniently be automated due to the simple structure of the cartridge. This is to be contrasted with existing cartridges which utilise a larger number of component parts and which must, therefore, be assembled by hand.

### BRIEF DESCRIPTION OF THE DRAWINGS

FIG. 1a is a schematic cross-sectional view of an electronic cigarette comprising a base part and a cartridge according to the present disclosure;

FIG. 1b is a schematic perspective view of the base part shown in FIG. 1a;

FIG. 2 is a schematic perspective view of the cartridge shown in FIG. 1a;

FIG. 3 is an exploded view of the cartridge shown in FIGS. 1a and 2;

FIG. 4 is a schematic perspective view in cross-section of the cartridge illustrated in FIGS. 1a, 2 and 3, wherein the arrow illustrates the flow of air and vapour through the cartridge;

FIG. 5 is an enlarged schematic view of part of the cartridge shown in FIG. 4, wherein the arrow illustrates the flow of vapour into a vapour outlet channel of the cartridge;

FIG. 6 is an enlarged schematic cross-sectional view of part of the cartridge illustrated in FIGS. 1a and 2 to 5;

FIG. 7 is a cross-sectional view along the line A-A in FIG. 6;

FIG. 8 is a schematic perspective view of the part of the cartridge illustrated in FIGS. 6 and 7;

FIGS. 9 and 10 are schematic perspective views respectively from above and below a heat transfer unit of the cartridge;

FIGS. 11a and 11b are respectively a schematic perspective view and a schematic cross-sectional view of an embodiment of an assembly of a sorption member between a heat transfer unit and a plug member;

FIGS. 12a to 12c are schematic views of a cartridge according to other exemplary embodiments of the present disclosure;

FIGS. 13a to 13f are schematic perspective views of exemplary embodiments of a heating element;

FIGS. 14 to 17 are schematic views of further examples of the heat transfer unit; and

FIG. 18 is a flowchart illustrating one example of a method for assembling a cartridge according to the present disclosure.

### DETAILED DESCRIPTION OF EMBODIMENTS

Embodiments of the present disclosure will now be described by way of example only and with reference to the accompanying drawings and in which like features are denoted with the same reference numerals.

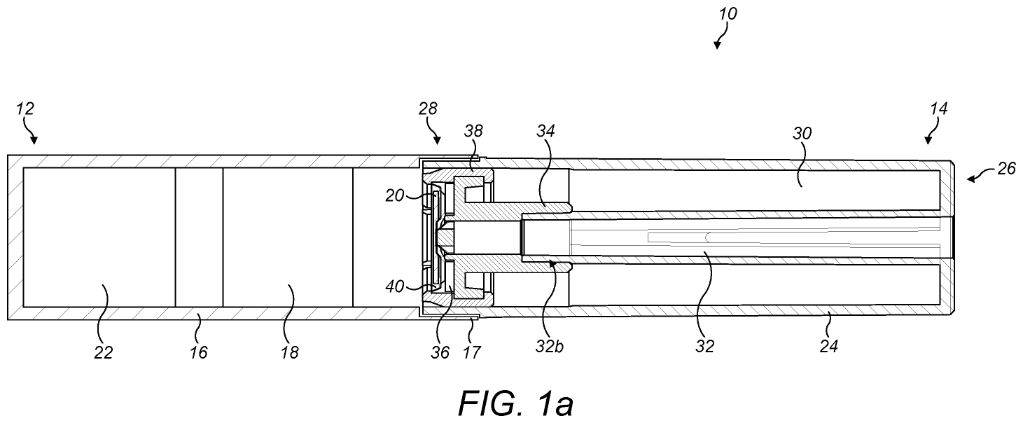

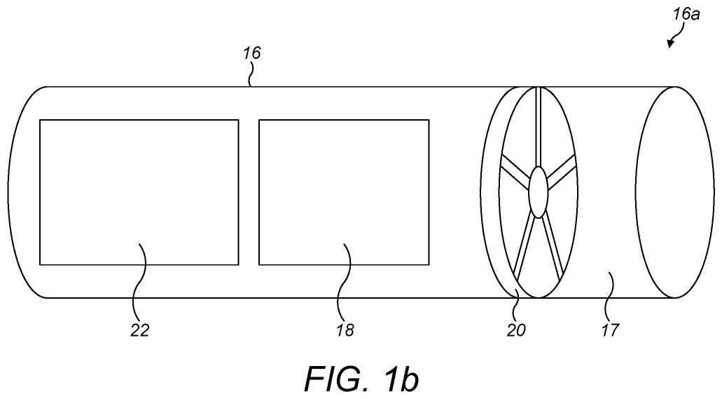

Referring initially to FIGS. 1a and 1b, there is shown an electronic an electronic cigarette 10 for vaporizing a liquid L. The electronic cigarette 10 can be used as a substitute for a conventional cigarette. The electronic cigarette 10 comprises a base part 12 and a cartridge 14 thermically connected to the base part 12. The base part 12 is thus the main body part of the electronic cigarette and is preferably re-usable.

The base part 12 comprises a housing 16 accommodating therein a power supply unit in the form of a battery 18 connected to a heating element 20 located at a first end 16a of the housing 16. The first end 16a of the housing 16 has an interface configured for matching a corresponding interface of the cartridge 14. The interface can be in the shape of a tubular cartridge seating 17 and comprises a connector for mechanically coupling the cartridge 14 to the cartridge seating 17. The battery 18 is configured for providing the heating element 20 with the necessary power for its operation, allowing it to become heated to a required temperature.

The battery 18 is also connected to a processor 22, enabling the required power supply for its operation. The processor 18 is operationally connected to the heating element 20. In the illustrated example, the processor 22 is located on an opposite side of the battery 18 to the heating element 20, wherein the battery 18 acts as a divider between the heating element 20 and other sensitive components of the electronic cigarette 10. However, this arrangement is not compulsory and other arrangements of the components within the base part 12 are entirely within the scope of the present disclosure.

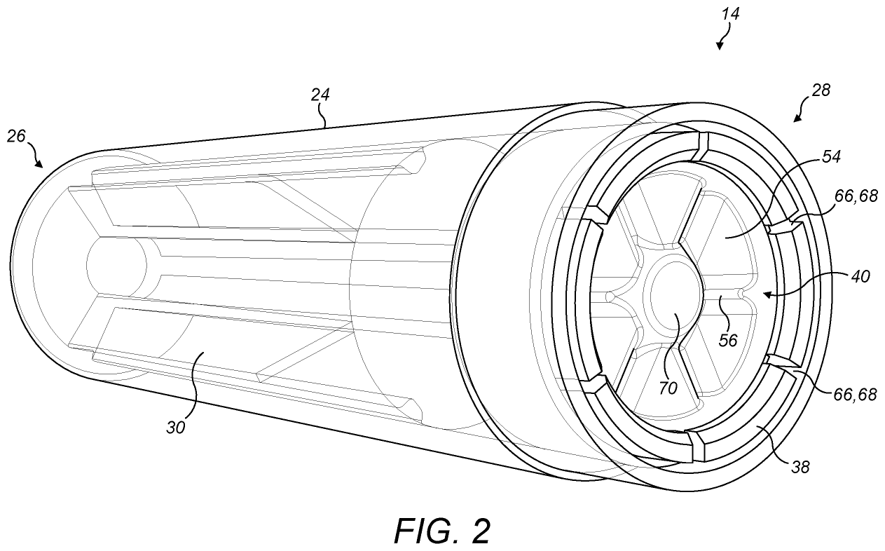

Referring additionally to FIGS. 2 to 5, the cartridge 14 comprises a cartridge housing 24 having a proximal end 26 and a distal end 28. The proximal end 26 may constitute a mouthpiece end configured for being introduced directly into a user's mouth (not shown). In some embodiments, a mouthpiece may be fitted to the proximal end 26. However, it is also possible to configure the electronic cigarette 10 with a separate mouthpiece portion, releasably connectable to the base part and whereby the cartridge 14 is enclosed inside the electronic cigarette 10. The cartridge 14 comprises a base portion and a liquid storage portion, where the liquid storage portion comprises a liquid store 30 configured for containing therein the liquid L to be vaporized and a vapour outlet channel 32. The liquid L may comprise an aerosol-forming substance such as propylene glycol and/or glycerol and may contain other substances such as nicotine and acids. The liquid L may also comprise flavourings such as e.g. tobacco, menthol or fruit flavour. The liquid store 30 may extend between the proximal end 26 and the distal end 28, but is spaced from the distal end 28. The liquid store 30 may surround, and coextend with, the vapour outlet channel 32.

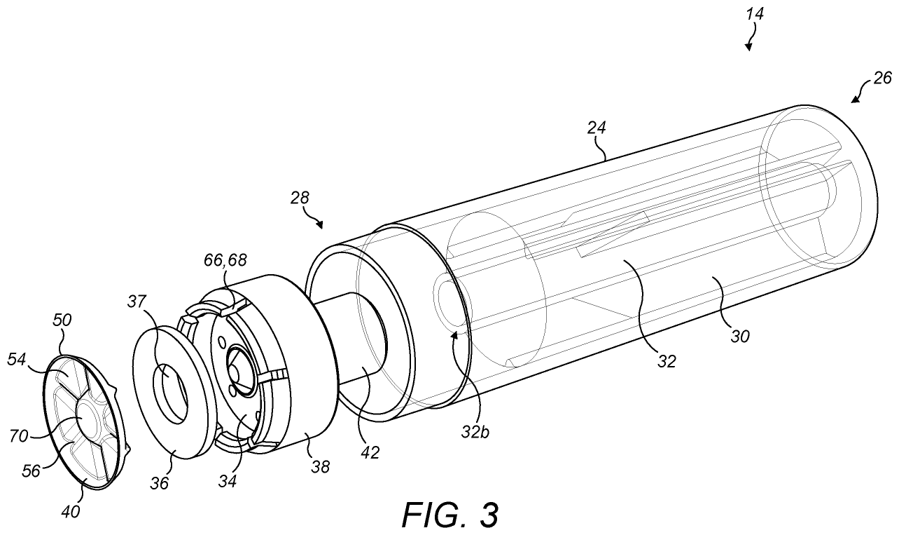

As best seen in FIG. 3, the base portion of the cartridge 14 may be configured to sealingly close off the distal end 28 of the cartridge 14. The base portion comprises a plug member 34, a disc shaped sorption member 36 having a centrally positioned hole 37 and a heat transfer unit 40 which are all positioned at the distal end 28 of the cartridge housing 24, and more particularly in the space formed between the liquid store 30 and the distal end 28. The plug member 34 closes the distal end 28 of the cartridge housing 24 and thereby retains the liquid L in the liquid store 30.

The plug member 34 is provided with a circumferential surface that is in contact with the inner circumferential surface of the liquid store 30. The plug member 34 may be formed of a material with an elasticity that provides a sealing effect when the circumferential surface contacts the inner circumferential surface of the liquid store 30. For example, the plug member 34 may comprise rubber or silicone. Alternatively, the plug member 34 may comprise a thermoplastic material which enables the plug member 34 and the liquid store 30 to be joined together by e.g. ultrasonic welding.

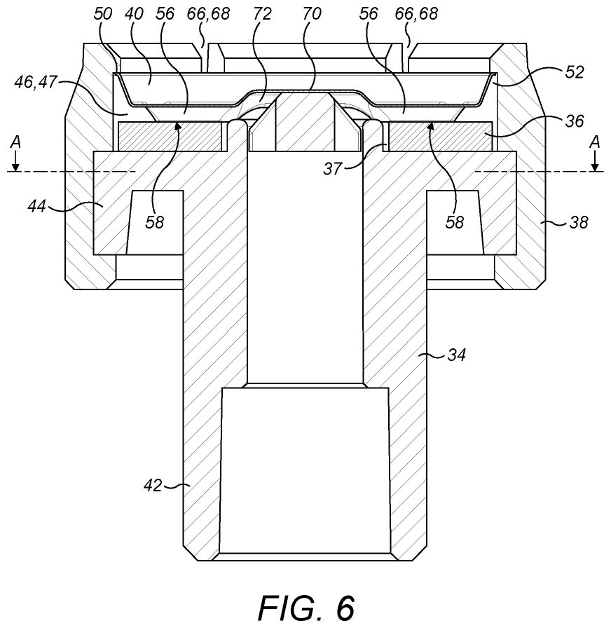

Alternatively, and as shown in the embodiment of FIGS. 3 to 8, the base portion may comprise a separate circumferential seal 38 which provides a circumferential surface that seals between the plug member 34 and the inner circumferential surface of the liquid store 30.

The plug member 34, best seen in FIGS. 3 and 6 to 8, comprises a first connection end 42 which is configured to sealingly connect to a distal end 32b of the vapour outlet channel 32 as shown in FIGS. 1, 4 and 5. The first connection end 42 may extend into the liquid store 30 and may include an annular flange configured to seal against the outer circumference of the vapour outlet channel 32. The plug member 34 also comprises a second connection end 44 which is configured to abut against an inner circumference of the circumferential seal 38.

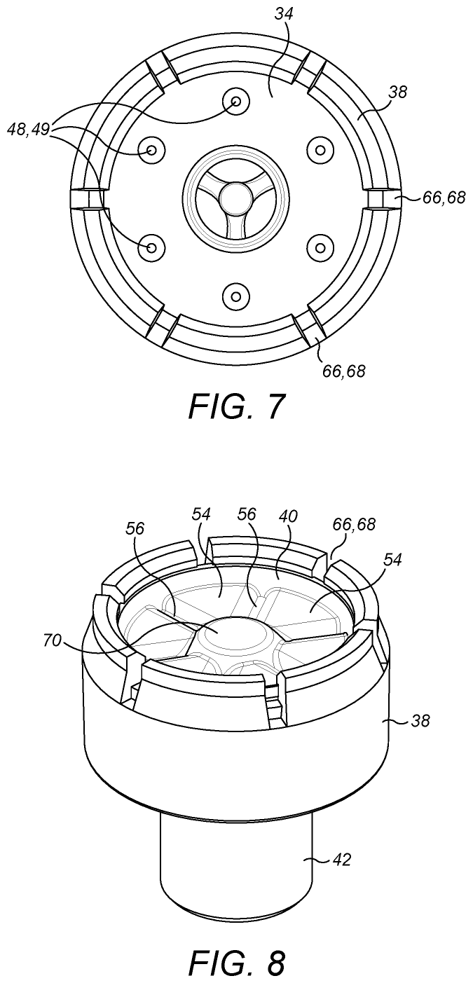

The plug member 34 includes a cavity 46 which is defined between the plug member 34 and the heat transfer unit 40. The cavity 46 accommodates the disc shaped sorption member 36 and a vaporization chamber 47. As best seen in FIG. 7, the plug member 34 may include a plurality of circumferentially spaced liquid outlets 48 which constitute a liquid outlet 49 of the liquid store 30. The liquid outlets 48 provide a controlled flow of liquid L from the liquid store 30 to the sorption member 36 positioned in the cavity 46 adjacent to the liquid outlets 48.

The sorption member 36 is positioned in the cavity 46 of the plug member 34 between the liquid outlets 48 and the heat transfer unit 40. The sorption member 36 is configured, on the one hand, for absorbing therein some of the liquid L, and, on the other hand, for being heated by the heat transfer unit 40 thereby allowing the liquid L absorbed therein to be vaporized in the vaporization chamber 47 constituted by the cavity 46.

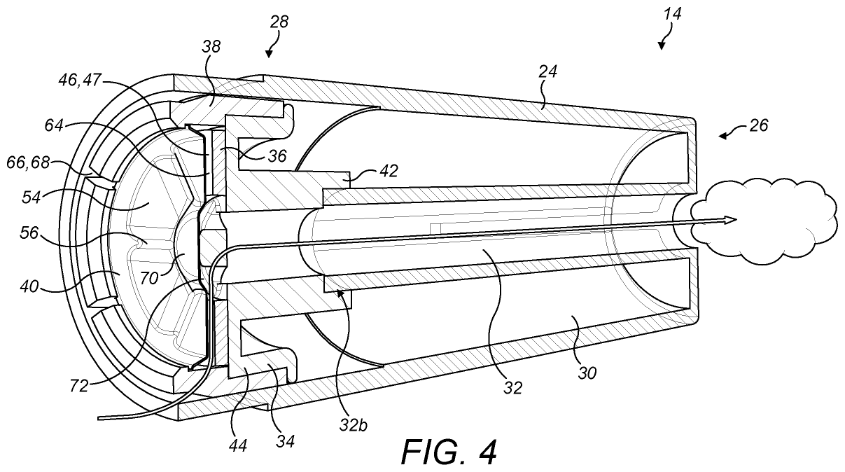

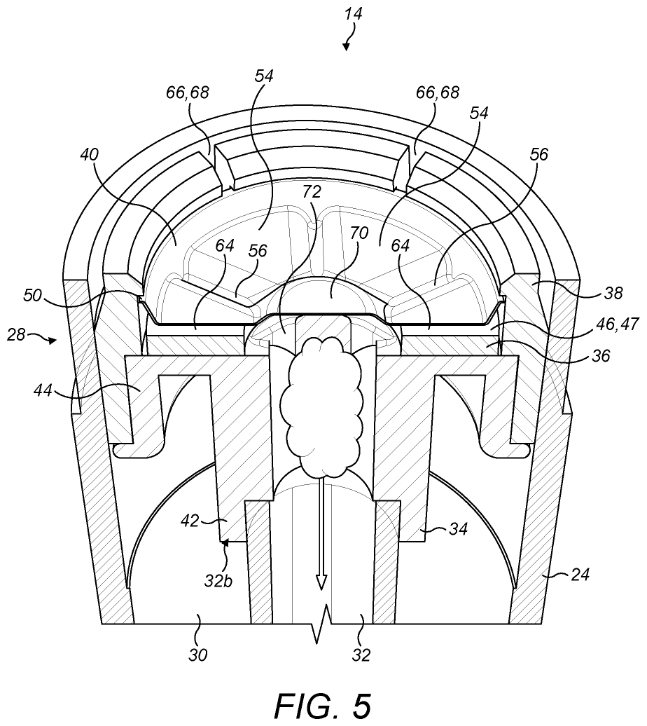

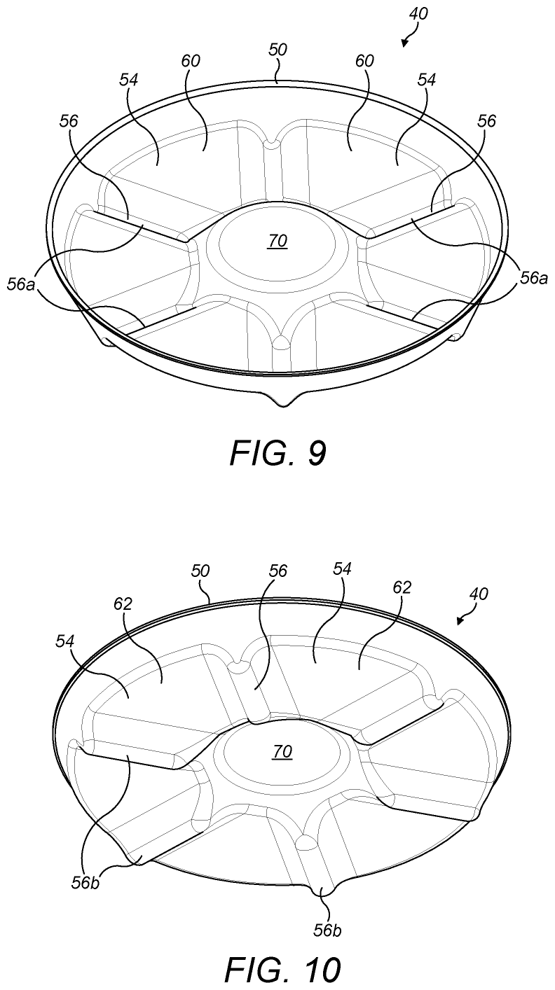

Referring additionally to FIGS. 9 and 10, the heat transfer unit 40 generally has a cross-sectional shape corresponding to the cross-sectional shape of the cartridge 14. In the embodiments illustrated in FIGS. 9 and 10, the cartridge 14 has a circular cross-section and, thus, the heat transfer unit 40 is circular or disc shaped and is provided with a circumferential edge 50. The circumferential seal 38 comprises an annular groove 52 which is configured to receive the circumferential edge 50 and the cooperation between the circumferential edge 50, the annular groove 52 and the plug member 34 thereby retains the heat transfer unit 40 in the desired position as best seen in FIGS. 4 and 5. The heat transfer unit 40 in turn is configured to retain the sorption member 36 in position in the vaporization chamber 47.

The heat transfer unit 40 comprises a plurality of first portions 54 lying substantially in a first plane and a plurality of second portions 56 which lie below the first portions 54 in a second plane that is substantially parallel with the first plane.

As best seen in FIGS. 9 and 10, the first and second portions 54, 56 are alternately and circumferentially spaced around the heat transfer unit 40, that is the second portions 56 are arranged circumferentially between the first portions 54. Referring in particular to FIGS. 4 to 6, it will be seen that the first portions 54 are spaced from the sorption member 36 whereas the second portions 56 contact the sorption member 36. Thus, the sorption member 36 and the heat transfer unit 40 are only in partial contact in contact zones 58. The heat transfer unit 40 can thus be seen as being provided with ridges 56b (see FIG. 10) on the side in contact with the sorption member 36 and with grooves 56a (see FIG. 9) on the side facing the heating element 20.

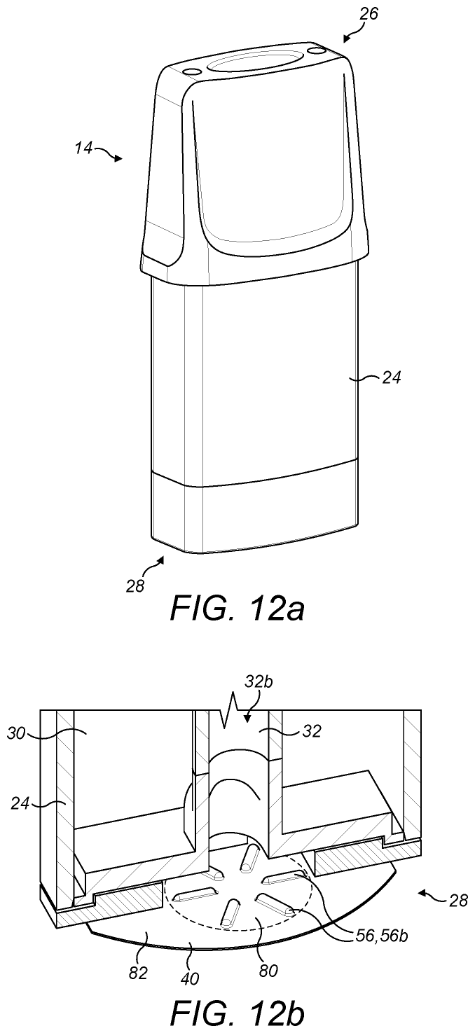

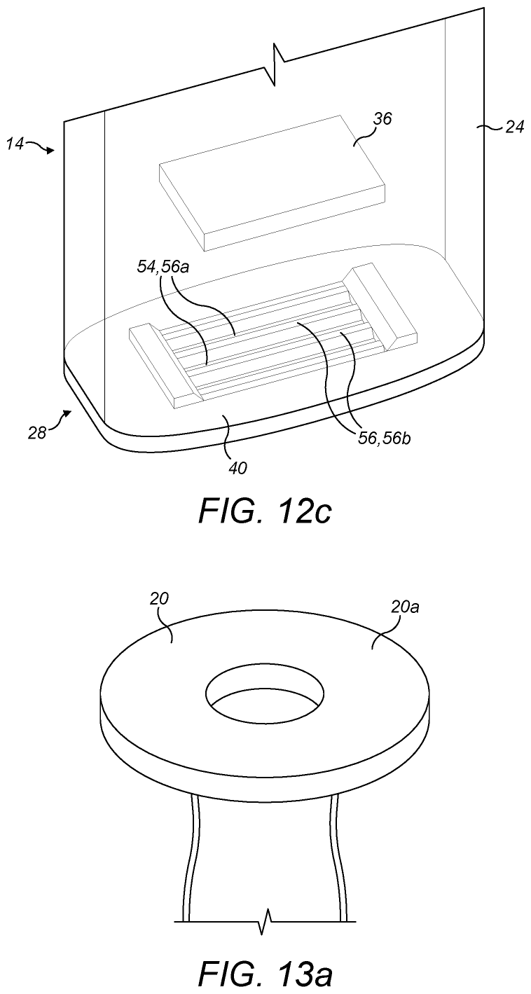

As illustrated in FIGS. 12a to 12c, the cartridge 14 may have a rectangular or oval cross-sectional shape. The heat transfer unit 40 may therefore also have a rectangular or oval cross-sectional shape. The heat transfer unit 40 may be provided with a heat transfer portion 80 and a connection portion 82. The connection portion 82 can be configured as a circumferential part or flange which is located radially outwardly of the grooves 56a and ridges 56b formed by the first portions 54 and the second portions 56, respectively. The flange may advantageously comprise a ferromagnetic material and can be configured for magnetic connection in a cartridge seating 17 comprising magnets. The flange of the heat transfer unit 40 is preferably flat and flush with the bottom housing of the cartridge 14. Alternatively, the flange can extend from the bottom surface of the cartridge 14. This enables the flange to contact and connect to the cartridge seating 17.

As illustrated in the embodiment of FIG. 12c, the first portions 54 and the second portions 56 can be linear and parallel to each other. This configuration is particularly advantageous for cartridges 14 with a rectangular cross-section, whereby the folding of the ridges 56b and grooves 56a can be easily achieved in a cutting and folding or stamping operation of a metallic sheet.

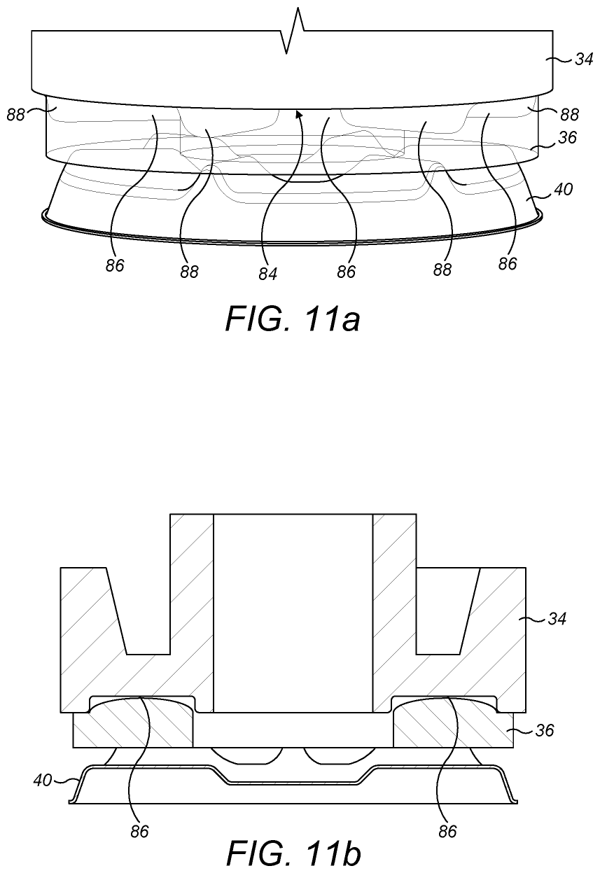

As illustrated in FIGS. 11a and 11b, the plug member 34 may have a non-planar surface 84. For instance, the non-planar surface 84 can be provided with cut-outs 86 and ridges 88. The ridges 88 can be aligned with the ridges 56b of the heat transfer unit 40, such that the contact zones 58 are created. The cut-outs 86 are aligned with vaporization zones 64 (see below) and further enhance the formation and escape of the vapour.

Referring again to FIGS. 9 and 10, the first portions 54 have a lower surface 62 which is spaced from the sorption member 36, thereby defining a plurality of vaporization zones 64 between the lower surface 62 of each of the first portions 54 and the sorption member 36 (see FIGS. 4 and 5). In some embodiments, the sorption member 36 may have a non-planar surface facing towards the heat transfer unit 40. For example, the non-planar surface can be formed by recessed areas which face towards and are aligned with the first portions 54 of the heat transfer unit 40, thus increasing the size of the vaporization zones 64.

The vaporization zones 64 form together the vaporization chamber 47 and facilitate vapour formation in the vaporization chamber 47 due to heating of the liquid L absorbed by the sorption member 36. In order to further facilitate vapour formation and provide a fluid flow route through the cartridge 14 for air and vapour, the cartridge 14 further comprises a plurality of circumferentially spaced air inlet openings 66, each aligned with a vaporization zone 64. The air inlet openings 66 may be constituted by slits 68 formed around the circumferential seal 38. The slits 68 are aligned with the first portions 54 of the heat transfer unit 40 and, hence, with the vaporization zones 64 to form the air inlet openings 66 to the vaporization zones 64. Another advantage of the slits 68 is that they enable the plug member 34 to flex such that the heat transfer unit 40 can be inserted into the plug member 34.

In addition to the first and second portions 54, 56, the heat transfer unit 40 may also comprise a central portion 70 which is raised substantially to the same level as the first portions 54 so that it lies substantially in the same first plane as the first portions 54. The raised central portion 70 defines a central chamber 72 (see FIGS. 4 and 5) which is fluidically connected to the vaporization zones 64 defined by each of the first portions 54. The central chamber 72 is fluidically connected to the vapour outlet channel 32, and in particular to the distal end 32b, and thus provides a route which allows vapour formed in the vaporization zones 64 to escape from the vaporization zones 64 and into the vapour outlet channel 32 before it is conveyed to the user via the proximal (mouthpiece) end 26.

As noted above, when the base part 12 and the cartridge 14 are assembled together as shown in FIG. 1, the heating element 20 of the base part 12 contacts the heat transfer unit 40 of the cartridge 14, such that the cartridge 14 is thermically connected to the base part 12. In operation, the heating element 20 is heated by the power from the battery 18 and provides its heat to the heat transfer unit 40 via conduction. The heat from the heat transfer unit 40 is then transferred to the sorption member 36, mainly by conduction through the second portions 56 (i.e. ridges 56b) in the contact zones 58. Thus, the sorption member 36 is heated indirectly via the heat transfer unit and not directly by the heating element 20 of the base part 12. As a result of heating of the sorption member 36, the liquid L absorbed therein from the liquid store 30 is vaporized in the vaporization chamber 47, and more particularly in the vaporization zones 64, and the vapour escapes from the vaporization zones 64 via the vapour outlet channel 32 as indicated by the arrows in FIGS. 4 and 5.

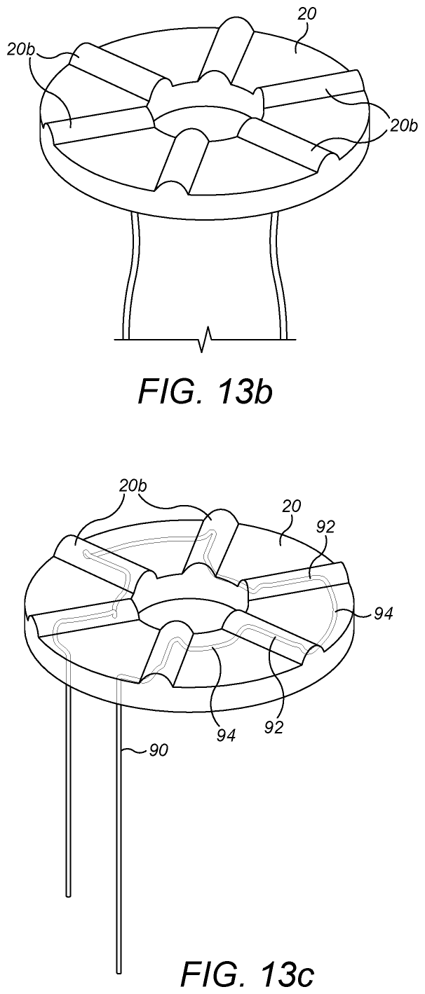

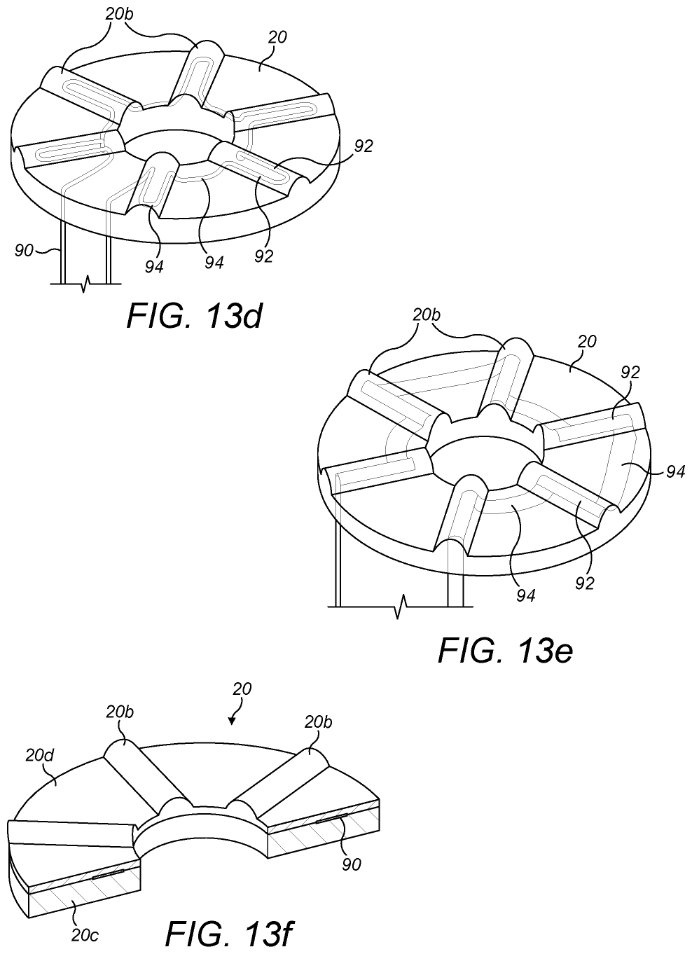

In one embodiment, the heating element 20 of the base part 12 comprises a substantially planar heat transfer surface 20a and may, for example, comprise a circular or disc shaped heating element 20 as shown in FIGS. 1 and 13a. In some embodiments, the heating element 20 may have a resistive heater element integrated into a solid body of non-electrically conductive material. The planar heat transfer surface 20a contacts the upper surface 60 of the first portions 54 when the cartridge 14 is assembled with the base part 12 as shown in FIG. 1, and thus heat is transferred from the heating element 20 to the heat transfer unit 40 primarily by conduction from the planar heat transfer surface 20a to the first portions 54. The second portions 56 are thereby heated indirectly by heat transferred from the first portions 54 to the second portions 56, and in turn the heat from the second portions 56 is transferred to the sorption member 36, mainly by conduction as described above.

In another embodiment, as illustrated in FIG. 13b, the heating element 20 of the base part 12 comprises a plurality of protruding heat transfer surfaces 20b, which may have a shape and form which can enter into the grooves 56a of the heat transfer unit 40. The heat transfer surfaces 20b are arranged to contact an upper surface of the second portions 56 when the cartridge 14 is assembled with the base part 12 as shown in FIG. 1, and thus heat is transferred from the heating element 20 to the heat transfer unit 40 primarily by conduction from the heat transfer surfaces 20b to the second portions 56. The second portions 56 are thereby heated directly by heat transferred from the heat transfer surfaces 20b of the heating element 20, and in turn the heat from the second portions 56 is transferred to the sorption member 36, mainly by conduction as described above.

Referring to FIG. 13c, in one example the heating element 20 includes an embedded resistive heater element 90, e.g., a heating wire, having a plurality of radial portions 92 and a plurality of connecting (e.g., circumferential) portions 94. The radial portions 92 are aligned with the heat transfer surfaces 20b, thus ensuring effective heating of the heat transfer surfaces 20b. In order to further increase the amount of heat generated in the heat transfer surfaces 20b, the resistive heater element 90 can be configured as shown in FIG. 13d so that two radial portions 92 are aligned with each heat transfer surface 20b.

The resistive heater element 90 can have a variable electrical characteristic along its length which generates more heat in the heat transfer surfaces 20b than in other areas of the heating element 20. For example, the resistive heater element 90 can be configured as shown in FIG. 13e so that the radial portions 92 have a higher electrical resistance than other portions of the resistive heater element 90 such as the connecting portions 94. The higher electrical resistance of the radial portions 92 could be achieved by modifying the shape, e.g., reducing the cross-sectional area, of the radial portions 92 of the resistive heater element 90 relative to the other parts of the resistive heater element 90, such as the connecting portions 94. Alternatively, or in addition, the higher electrical resistance of the radial portions 92 could be achieved by forming the radial portions 92 of a different material (with a higher electrical resistance) than the other parts of the resistive heater element 90, such as the connecting portions 94.

In some embodiments, the heating element 20 can have a multi-layer construction as shown in FIG. 13f. More particularly, the heating element 20 can comprise a first layer 20c comprising a thermally-insulating material and a second layer 20d comprising a thermally-conductive material, and the resistive heater element 90 can be positioned at the interface between the first and second layers 20c, 20d. When the heating element 20 is activated, the thermally-insulating first layer 20c and the thermally-conductive second layer 20d promote the transfer of heat from the resistive heater element 90 to the heat transfer surfaces 20b, thus helping to maximize heating efficiency.

The heating element 20 in the base part 12 ideally needs to reach around 500° C. in order to transfer enough heat such that the connection between the sorption member 36 and the heat transfer unit 40 reaches a temperature at which vaporization occurs (typically between 200° C. and 250° C.).

The grooves 56a in the heat transfer unit 40 and the protruding heat transfer surfaces 20b (i.e. ridges) of the heating element 20 enable a localized concentration of heat. The heat transfer unit can be manufactured by a suitable forming process using a sheet material having a high thermal conductivity and, e.g., a thickness of around 0.05 mm. Additionally, a thermal break can be created in the heat transfer unit 40 by the relatively thin sheet material and the non-planar structure. The heat transfer unit 40 may for instance comprise stainless steel (e.g. AISI 316 stainless steel), which creates a good localized heat transfer. The heat transfer unit 40 is on one hand highly thermally conductive but acts like a thermal break when it is bent. It is therefore an advantageous embodiment to only heat in the grooves 56a instead of on the planar upper surfaces 60 of the first portions 54. The thermal break also enables the portions of the heat transfer unit 40 other than the grooves 56a (i.e. the second portions 56) to remain cooler. This can also be advantageous in regions where it is desirable to avoid excessive heating, such as at the contact between the liquid cartridge housing and the heat transfer unit 40.

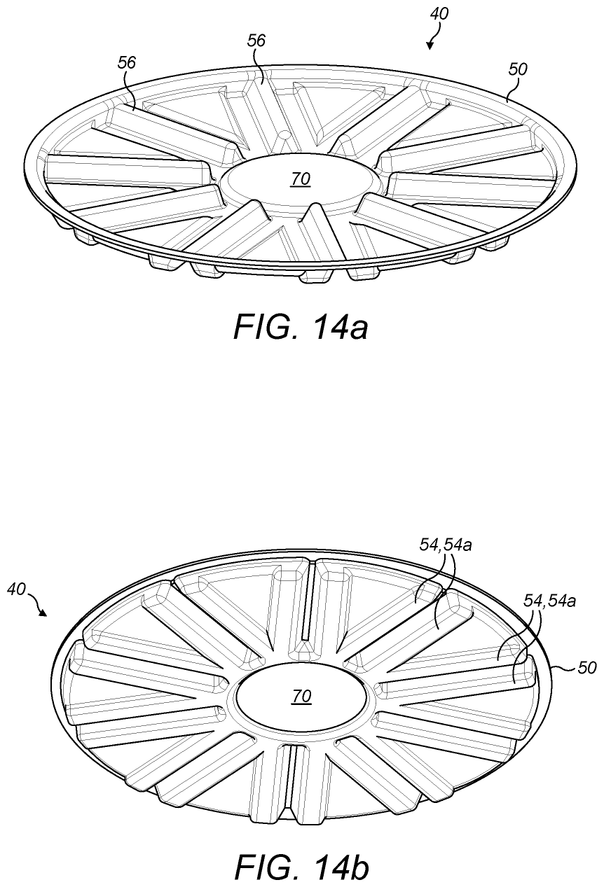

Other example geometries for the heat transfer unit 40 which provide for partial contact between the sorption member 36 and the heat transfer unit 40 in contact zones 58 will now be described with reference to FIGS. 14 to 17.

Referring to FIGS. 14a and 14b, the heat transfer unit 40 can be formed to provide a plurality of first portions 54 in the form of ribs 54a on the side in contact with the heating element 20. The ribs 54a are particularly well suited for contacting the planar disc-shaped heating element 20 shown in FIG. 13a and heat can be transferred efficiently from the heating element 20 to the heat transfer unit 40 because of the large number of ribs 54a. A heat transfer unit 40 having this geometry may be particularly, but not exclusively, suitable for manufacture by a stamping process.

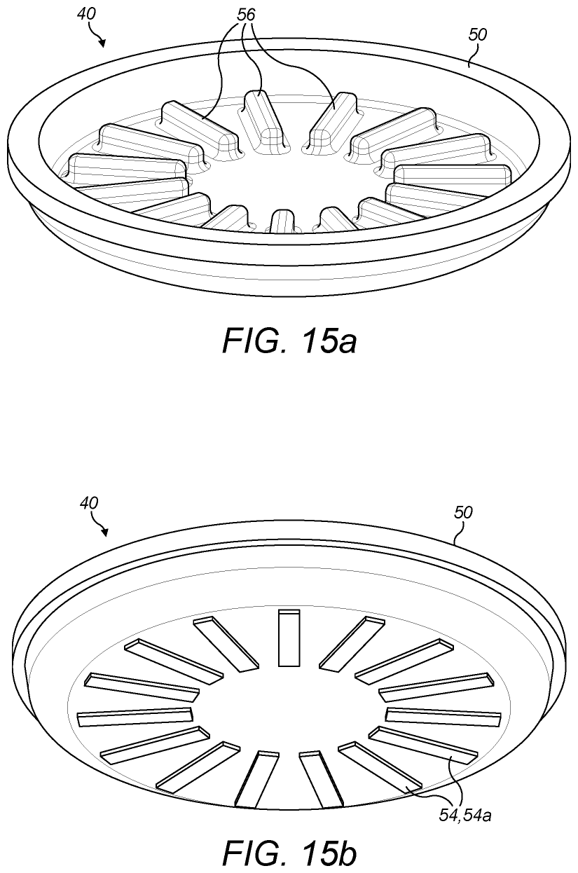

Referring to FIGS. 15a and 15b, the heat transfer unit 40 can be formed to provide a plurality of first portions 54 in the form of shallow ribs 54a on the side in contact with the heating element 20. The ribs 54a are particularly well suited for contacting the planar disc-shaped heating element 20 shown in FIG. 13a and heat can be transferred efficiently from the heating element 20 to the heat transfer unit 40 because of the large number of ribs 54a. A heat transfer unit 40 having this geometry may be particularly, but not exclusively, suitable for manufacture by a die casting process.

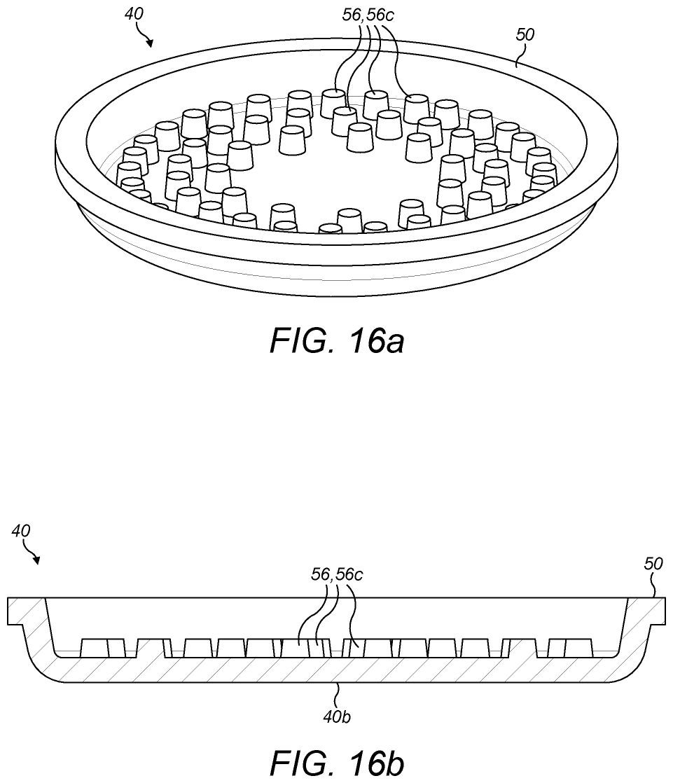

Referring to FIGS. 16a and 16b, the heat transfer unit 40 can be formed with a plurality of frustoconical projections 56c on the side in contact with the sorption member 36 and can have a planar surface 40b on the side in contact with the heating element 20. The planar surface 40b is particularly well suited for contacting the planar disc-shaped heating element 20 shown in FIG. 13a and heat can be transferred efficiently from the heating element 20 to the heat transfer unit via the planar surface 40b. A heat transfer unit 40 having this geometry may be particularly, but not exclusively, suitable for manufacture by a cold forging process.

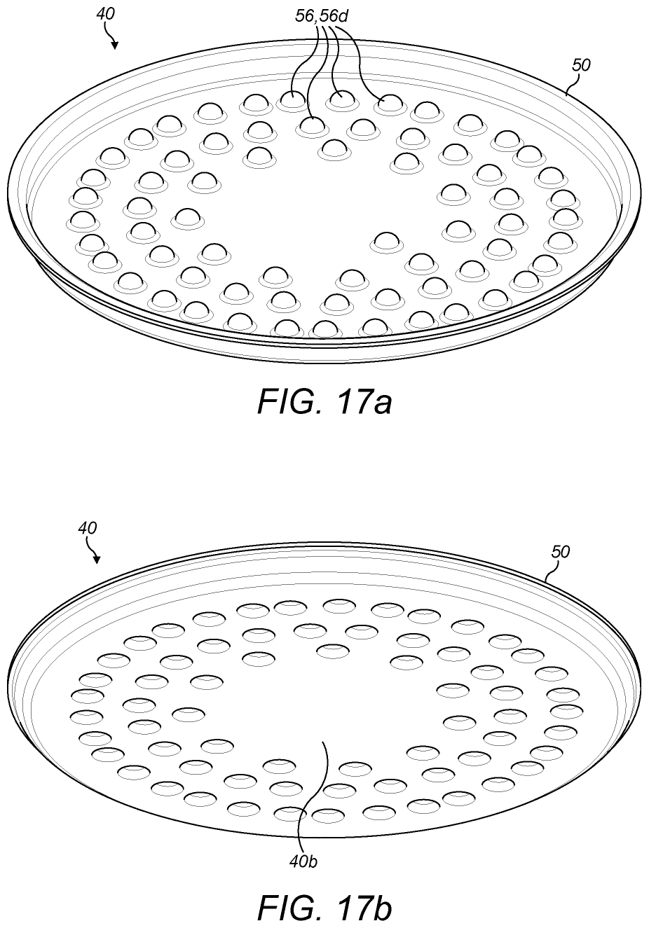

Referring to FIGS. 17a and 17b, the heat transfer unit 40 can be formed with a plurality of nodules 56d, e.g., with a hemispherical shape, on the side in contact with the sorption member 36 and can have a substantially planar surface 40b on the side in contact with the heating element 20. The substantially planar surface 40b is particularly well suited for contacting the planar disc-shaped heating element 20 shown in FIG. 13a and heat can be transferred efficiently from the heating element 20 to the heat transfer unit 40 via the substantially planar surface 40b. A heat transfer unit 40 having this geometry may be particularly, but not exclusively, suitable for manufacture by a stamping process.

Another advantage of the cartridge 14 according to the present disclosure is that it can be assembled with relative ease due to its simplified structure, and the assembly can advantageously be automated. The individual parts that need to be assembled together comprise the plug member 34, the sorption member 36 and the heat transfer unit 40. Optionally, a circumferential seal 38 is also introduced between the plug member 34 and the liquid store 30. The heat transfer unit 40 can be advantageously formed by a metal stamping process using a stamping tool having one part corresponding to the upper side of the heat transfer unit 40 and another part corresponding to the opposite lower side of the heat transfer unit 40. In such a way, the grooves 56a can be shaped and the corresponding deformation of the grooves 56a is accommodated by the raised central portion of the tool. Hence, the formation of the grooves 56a and depressed ridges 56b need to be compensated by the simultaneous formation of the raised central portion 70.

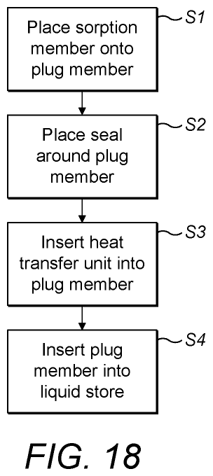

As illustrated in FIG. 18, an exemplary assembly method comprises the steps of:
S1—Placing the sorption member 36 onto the plug member 34;
S2—Placing the circumferential seal 38 around the plug member 34;
S3—Inserting the heat transfer unit 40 into the plug member 34; and
S4—Inserting the plug member 34 into the liquid store 30.

Optionally, step S2 can be omitted if the plug member 34 is configured to flex (to receive the heat transfer unit 40) and to be connected (e.g. by ultrasonic welding) to the inner surface of the liquid store 30.

In step S1, the plug member 34 is provided and the disc shaped sorption member 36 is placed in the cavity 46 of the plug member 34. The method then comprises attaching the heat transfer unit to the plug member 34, in particular by engaging the circumferential edge 50 of the heat transfer unit 40 in the annular groove 52 of the circumferential seal 38.

The sorption member 36 is secured in the cavity 46 by the heat transfer unit 40 and, as discussed above, the sorption member 36 and the heat transfer unit 40 are only in partial contact with each other in the contact zones 58. Finally, the plug member 34, along with the sorption member 36, the circumferential seal 38 and the heat transfer unit 40 assembled thereto, is inserted into the distal end 28 (i.e. the open end) of the cartridge housing 24 such that the first protruding connection end 42 of the plug member 34 is sealingly connected with the distal end 32b of the vapour outlet channel 32.

The skilled person will realize that the present invention by no means is limited to the described exemplary embodiments. The mere fact that certain measures are recited in mutually different dependent claims does not indicate that a combination of these measures cannot be used to advantage. Moreover, the expression “comprising” does not exclude other elements or steps. Other non-limiting expressions include that “a” or “an” does not exclude a plurality and that a single unit may fulfil the functions of several means. Any reference signs in the claims should not be construed as limiting the scope. Finally, while the invention has been illustrated in detail in the drawings and in the foregoing description, such illustration and description is considered illustrative or exemplary and not restrictive; the invention is not limited to the disclosed embodiments.

1. A cartridge for an electronic cigarette, the cartridge being configured to thermically connect to a base part of the electronic cigarette having at least one heating element, the cartridge comprising:
a liquid store comprising a liquid outlet;
a vaporization chamber in communication with the liquid store via the liquid outlet;
a sorption member in the vaporization chamber for absorbing liquid transferred to the vaporization chamber via the liquid outlet; and
a heat transfer unit configured, when the cartridge is thermically connected to the base part, to transfer heat from the at least one heating element to the sorption member to vaporize liquid absorbed by the sorption member;
wherein the sorption member and the heat transfer unit are only in partial contact in contact zones.

2. The cartridge according to claim 1, wherein the heat transfer unit comprises a plurality of first portions lying substantially in a first plane and a plurality of second portions stepped out of the first plane and lying substantially in a second plane that is below and substantially parallel with the first plane, the plurality of second portions contacting the sorption member in the contact zones.

3. The cartridge according to claim 2, wherein the heat transfer unit further comprises a substantially circular heat transfer unit, wherein the plurality of first portions are circumferentially spaced around the heat transfer unit and the plurality of second portions are circumferentially spaced around the heat transfer unit.

4. The cartridge according to claim 3, wherein the plurality of second portions are arranged circumferentially between the plurality of first portions.

5. The cartridge according to claim 2, wherein the plurality of first portions are substantially planar and have an upper surface configured to contact the at least one heating element of the base part, and wherein a plurality of vaporization zones is formed between a lower surface of the plurality of first portions and the sorption member.

6. The cartridge according to claim 5, wherein the cartridge further comprises a plurality of air inlets in communication with the plurality of vaporization zones, and wherein at least one of the plurality of air inlets is in communication with each of the plurality of vaporization zones.

7. The cartridge according to claim 5, wherein the cartridge further comprises a housing, a plug member and a circumferential seal, and wherein the plug member is configured to retain the heat transfer unit and the heat transfer unit is configured to retain the sorption member.

8. The cartridge according to claim 7, wherein the circumferential seal comprises a plurality of slits aligned with the plurality of first portions, whereby the plurality of slits form air inlet openings to the plurality of vaporization zones.

9. The cartridge according to claim 1, wherein the cartridge further comprises a circumferential seal, and wherein the heat transfer unit is received in the circumferential seal.

10. The cartridge according to claim 9, wherein the circumferential seal comprises an annular groove configured to receive a circumferential edge of the heat transfer unit.

11. The cartridge according to claim 7, wherein the plug member comprises a first protruding connection end configured to sealingly connect to a vapour outlet channel of the housing and a second connection end configured to seal against an inner circumference of the circumferential seal.

12. The cartridge according to claim 7, wherein the plug member comprises a plurality of liquid outlets from the liquid store, where each of the plurality of vaporization zones is aligned with at least one of the plurality of liquid outlets.

13. The cartridge according to claim 5, wherein the heat transfer unit further comprises a central portion that lies substantially in the first plane and thereby defines a central chamber, the plurality of first portions are fluidically connected with the central chamber, and the central chamber is fluidically connected to a vapour outlet channel, whereby vapour can be transferred from each of the plurality of vaporization zones to the vapour outlet channel.

14. The cartridge according to claim 5, wherein the sorption member includes a hole extending therethrough for establishing fluid communication between the plurality of vaporization zones and a vapour outlet channel.

15. An electronic cigarette comprising:
a base part having at least one heating element; and
the cartridge according to claim 1 thermically connected to the base part.

16. The electronic cigarette according to claim 15, wherein the heat transfer unit comprises a plurality of first portions lying substantially in a first plane and a plurality of second portions stepped out of the first plane and lying substantially in a second plane that is below and substantially parallel with the first plane, the plurality of second portions contacting the sorption member in the contact zones, and wherein the at least one heating element comprises a substantially planar heat transfer surface in contact with the plurality of first portions.

17. The electronic cigarette according to claim 15, wherein the heat transfer unit comprises a plurality of first portions lying substantially in a first plane and a plurality of second portions stepped out of the first plane and lying substantially in a second plane that is below and substantially parallel with the first plane, the plurality of second portions contacting the sorption member in the contact zones, and wherein the at least one heating element comprises a plurality of heat transfer surfaces in contact with each of the plurality of second portions.

18. An assembly method for a cartridge for an electronic cigarette, the cartridge comprising a housing having a closed end and an open end configured to receive a plug member, the method comprising the steps of:
providing a plug member with a cavity;
placing a disc shaped sorption member in the cavity;
attaching a heat transfer unit to the plug member such that the heat transfer unit secures the sorption member in the cavity and such that the sorption member and the heat transfer unit are only in partial contact in contact zones; and
introducing the plug member into the open end of the housing.
